(19) United States
(12) Patent Application Publication
(10) Pub. No.: US 2004/0212204 A1
(43) Pub. Date: Oct. 28, 2004

(54) Posthole digger

(76) Inventor: David C. Swartz, Ashville, NY (US)

Correspondence Address: WAYNE L LOVERCHECK ESQ, LOVERCHECK & LOVERCHECK PC, 931 STATE ST, ERIE, PA, 16501-1451, US

(21) Appl. No.: 10/423,329

(22) Filed: Apr. 25, 2003

(51) Int. Cl. A01B 1/16

(52) U.S. Cl. 294/50.8

(57) ABSTRACT

A posthole digger for digging deeper and narrower holes while maintaining a general uniform diameter therethrough includes a pair of handles that are offset and angled from each other so that their movement doesn't occur in the same plane, and secured at the lower end of each handle is a blade having a lessened radius of curvature for excavating holes. Each blade includes a neck portion and the neck portions partially overlap for receiving a primary attaching fastener that provides the pivot point for the handles and blades. In addition, the neck portion of each blade has formed thereon a slide slot that aligns with a respective aperture formed on the other neck portion. The slide slots delimit the range of pivotal movement of the handles and blades, prevent the blades from striking each other during the excavation process, and set the position of the handles for opening and closing the blades.

### FIELD OF THE INVENTION

The present invention pertains to tools and digging implements, and, more particularly, pertains to a posthole digger for excavating holes having a generally uniform diameter throughout their depth.

### BACKGROUND OF THE INVENTION

In order to dig holes for placing therein posts, uprights or stanchions that form the supports for decks, porches, sheds, garages, and many other structures, a manually operable piece of equipment referred to as a posthole digger is used.

Manually operable posthole diggers of the standard clamshell design include four primary elements: two elongated handles and two curvilinear digging scoops with each scoop secured to the lower end of each handle. The handles are pivotally attached adjacent their lower end, and the handles are disposed generally parallel to each other or are moved toward each other to open the scoops for digging into the earth to create the hole. The handles are then pulled or moved away from each other to close the scoops for retaining an amount of soil therein. The scoops are then lifted out of the hole still closed upon and holding the quantity of soil therein, and then the scoops are opened up away from the hole by moving the handles toward each other. After the quantity of soil has been released from the scoops, the open scoops are then driven into the hole for the next digging operation.

A primary problem with the standard clamshell-type posthole digger is that as the hole is dug deeper, the worker is unable to spread the handles far enough away from each other to allow the scoops to enclose a sufficient quantity of soil therebetween. The diameter of the hole essentially prevents the handles from achieving a proper range of motion to allow for the continued scooping of the dirt and removal of the dirt from the hole. Thus, the only recourse is to enlarge the diameter of the hole but this adds an unnecessary amount of work to the task of digging the hole to a desired depth.

As a result the prior art discloses a variety of hole diggers for digging deeper holes while attempting to maintain the uniform diameter of the holes.

The Nivison patent (U.S. Pat. No. 397,383) and West patent (U.S. Pat. No. 934,029) disclose relatively early hole diggers.

The Weiland patent (U.S. Pat. No. 4,042,270) discloses a posthole digger having a scissor type configuration for arm members so that the handles are located opposite of the spades.

The Merry patent (U.S. Pat. No. 4,489,969) discloses a clam digging tool having crossed handles and wherein a strap is used to define the range of movement of the blades during clam digging.

The Burnham patent (U.S. Pat. No. 5,320,363) discloses a posthole digger having a pair of pivotal handles attached to shaft assemblies for actuating pivotally mounted blades when the handles are pivoted inwardly toward each other.

The Robinson patent (U.S. Pat. No. 5,427,424) discloses a single handle posthole digger wherein depression of an actuator lever by the worker transmits pivotal motion to a movable blade for effecting hole excavation.

The Aaland patent (U.S. Pat. No. 5,478,128) discloses a posthole digger having transverse handles interconnected to opposed blades that are held apart by a coil spring.

The Vaughter patent (U.S. Pat. No. 6,068,315) discloses a posthole digger having a pair of handles to which blades are pivotally mounted. A movable collar is mounted on the handles for regulating the operation of the digger.

The Marcus patent (U.S. Pat. No. 5,820,183) discloses the use of marking or gradation indicia on the handles of tools and garden equipment.

The Pickren patent (U.S. Pat. No. 6,089,632) discloses a posthole digger having a pair of handles that partially pass by each other during the digging of a hole, and a pair of blades interconnected by a pair of hinge brackets.

Nonetheless, despite the ingenuity of the above inventions, there remains a need for a posthole digger that can dig deep, narrow holes while maintaining the uniform diameter of the holes throughout the digging process and which increases the leverage of the digger through a smooth, efficient movement and operation of the handles and interconnected blades.

### SUMMARY OF THE INVENTION

The present invention comprehends a posthole digger for digging and excavating holes to a greater than standard depth and for maintaining a generally constant diameter of the hole. The posthole digger of the present invention includes a pair of handles that are angled toward each other when the posthole digger is in the open position, and are also offset from each other so that the handles are able to pass by each other during operation. Secured to the lower end of each handle is a blade that includes a cut out portion, an intermediate neck portion and a scoop portion that terminates with an excavating edge. A primary attachment fastener extends transversely through both neck portions where the neck portions overlap each other and provides the pivot point for the posthole digger whereupon the handles and blades pivot on the primary attachment fastener. In addition, the neck portion of each handle includes a slide slot that is axially aligned with a respective aperture formed on the partially overlapped neck portion of the other blade. One slide bolt is received through each pair of aligned slide slots and apertures and the slide bolts move within the slots concomitant with the worker opening and closing the handles. The slide slots define the range of movement of the handles and the working range of the blades throughout their opening and closing when excavating dirt from a hole and depositing the dirt external to the hole.

It is an objective of the present invention to provide a posthole digger for excavating a deeper than standard depth hole while maintaining the generally uniform diameter of the hole throughout its depth.

It is another objective of the present invention to provide a posthole digger that allows the worker to excavate a hole by using either a side by side operational movement or a push pull movement, that is, by adduction or abduction.

It is yet another objective of the present invention to provide a posthole digger wherein the handles both overlap each other at their upper ends and are offset from each other in order for the worker to avoid striking his hands and fingers against each other during operation of the posthole digger.

It is still another objective of the present invention to provide a posthole digger wherein the handles start in an overlapped position and then are moved away from each other for commencing the hole excavation process.

It is still yet another objective of the present invention to provide a posthole digger wherein the movement of the handles to the open position is limited to thereby allow for the excavation of a deeper hole having a generally uniform diameter.

Still yet another objective of the present invention is to provide a posthole digger that allows the worker to pull on only one handle against the side of the hole to thereby effect the scooping of dirt from the hole.

A still further objective of the present invention is to provide a posthole digger wherein the blades include a cut out portion for increasing the leverage transmitted to the edge of the blade during the excavation of the hole.

A yet still further objective of the present invention is to provide a posthole digger wherein each blade has a lessened radius of curvature that allows for an easier and more efficient cutting of the sides of the hole.

Yet another objective of the present invention is to provide a posthole digger that regulates and controls the movement of the handles and blades when moving between the full open position and the full closed position for providing a smoother, more efficient operation of the posthole digger.

Yet still another objective of the present invention is to provide a posthole digger wherein the blades includes opposed slide slots for delimiting the movement of the blades and for abruptly stopping the movement of the blades at the full open position for facilitating the shaking and removal of dirt from the blades.

Another objective of the present invention is to provide a posthole digger wherein the slide slots and the offset mounting of the handles with respect to each other diminishes the likelihood of weaving and sloppy movement by the handles and blades during operation thereof.

These and other objects, features, and advantages will become apparent to one skilled in the art upon a perusal of the following detailed description of the preferred embodiment when read in conjunction with the following drawings.

### BRIEF DESCRIPTION OF THE DRAWINGS

FIG. 1 is a front elevational view of the posthole digger of the present invention illustrating the offset and overlapped handles;

FIG. 2 is a side elevational view of the posthole digger of the present invention illustrating the posthole digger in the open position;

FIG. 3 is a top plan view of one blade of the posthole digger illustrating the lessened radius of curvature of the blade;

FIG. 4 is a perspective view of the posthole digger illustrating the slide slots located on the blades and the position of the blades when disposed in the open position;

FIG. 5 is a perspective view of the posthole digger illustrating the position of the handles and blades When disposed in the open position; and

FIG. 6 illustrates the configuration of a hole dug by the posthole digger of the present invention relative to the configuration of a hole dug by a standard posthole digger.

FIG. 7 is a perspective view of the posthole digger blade of the present invention illustrating the scoop and bracket portions of the blade.

### DETAILED DESCRIPTION OF THE PREFERRED EMBODIMENT

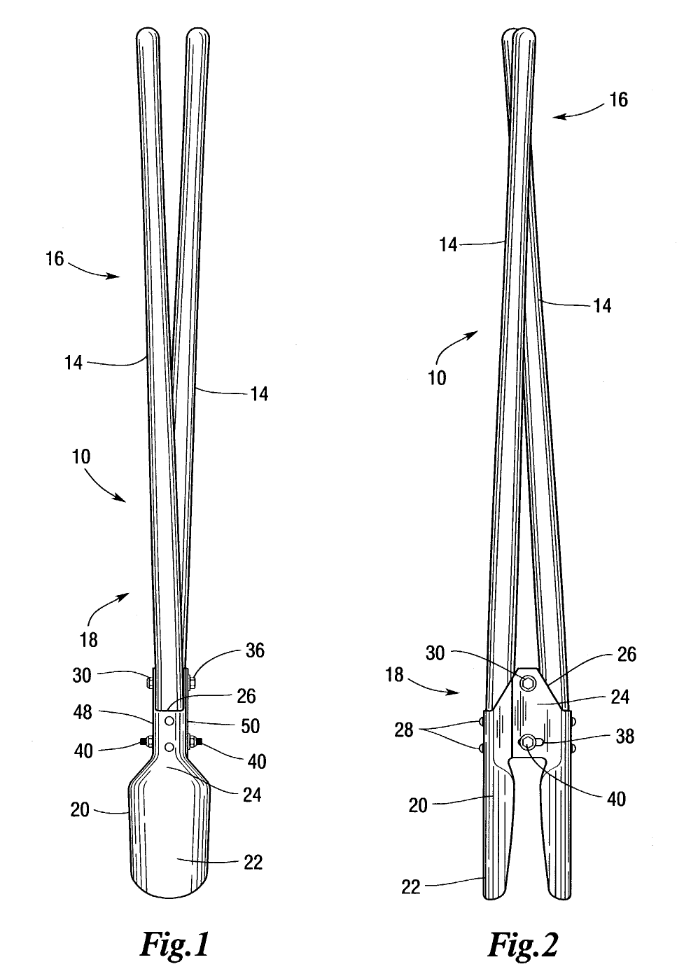

Illustrated in FIGS. 1 through 7 is a hole digger for digging deeper and straighter holes while maintaining the generally uniform diameter of the holes throughout their depth. The hole digger is specifically a posthole digger 10 for excavating holes such as the representative hole 12 shown in FIG. 6. Posthole digger 10 of the present invention allows the individual to excavate a generally straight, uniform hole by avoiding, among other things, the weaving and sloppiness that is inherent in standard clamshell-type posthole diggers.

As shown in FIGS. 1 through 7, posthole digger 10 includes a pair of elongated, manually operable handles 14 that are capable of a side-to-side or a push-pull movement, i.e., adduction or abduction. As shown most distinctly in FIGS. 1 and 2, handles 14 are inclined or angled toward each other at an approximate angle of 5 degrees when disposed in what may be denoted as the open position (illustrated in FIG. 1). In addition, handles 14 are disposed in an offset arrangement whereby handles 14 do not move in the same vertical plane as they are opened and closed for digging and removing soil during the excavating of hole 12. As shown in FIG. 2, handles 14 initially start out in the overlapped open position, and then are moved away from each other to dig and remove dirt.

Handles 14 are pivotally interconnected, as will be hereinafter further described, and each handle 14 includes an upper manually graspable end 16 and an opposite lower end 18. The offsetting arrangement of handles 14 avoids the problem of the individual striking his or her hands against each other as handles 14 are brought together during the hole digging process. The typical length of each handle 14 may be approximately 52 inches to provide more leverage and the capability of digging deeper and more uniform holes such as hole 12 of FIG. 6. Handles from 48 inches to 144 inches can be used with this hole digger to provide adequate leverage while maintaining the capability of digging deeper and more uniform holes such as hole 12 of FIG. 6.

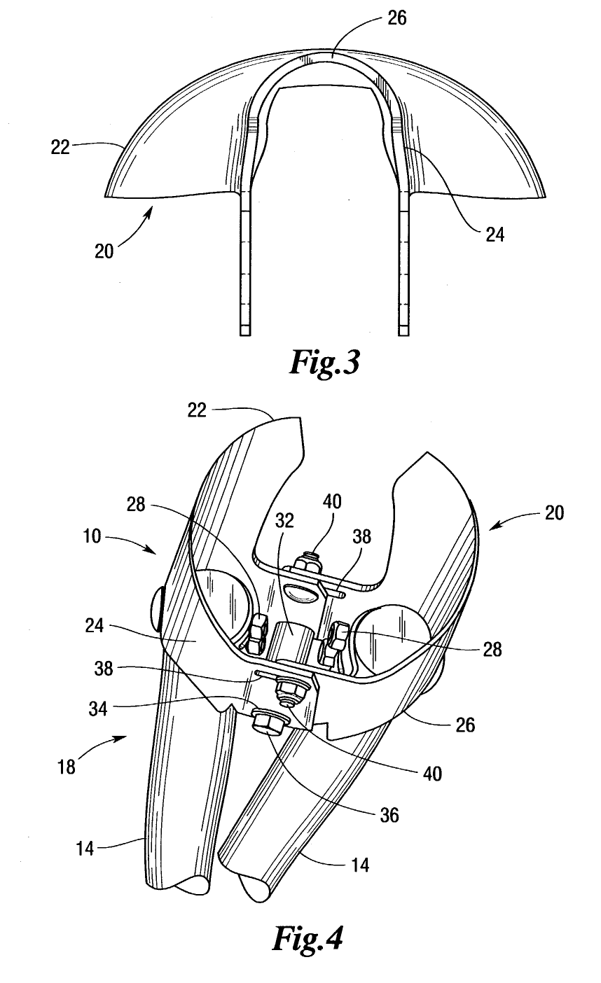

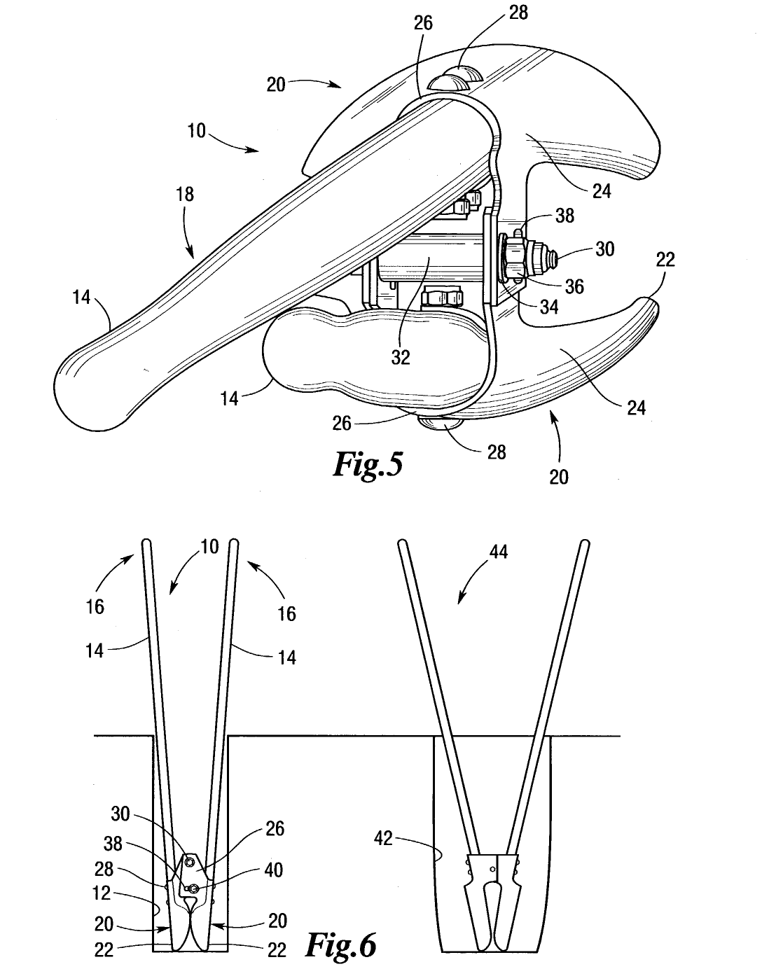

Illustrated in FIGS. 1 through 7 is a pair of digging blades 20 that incorporate a number of features for digging deeper and more uniform holes. Each blade 20 includes a scoop portion 22, a neck or hinge bracket portion 24 and a cut-out portion 26; the scoop portions 22 of blades 20 have a generally flattened or lessened radius of curvature while neck portions 24 are generally oblong-shaped. Neck portions 24 are generally wider for providing better leverage and securement to handles 14 while scoop portions 22 are generally shorter and flatter for easier hole digging and for digging holes of more uniform circularity. In addition, each neck portion 24 includes opposed ear-like extensions generally parallel to each other and extending transverse to blades 20. The flatter scoop portions 22 obviate the need to chop into the ground a number of times to create a uniform hole. The flatter scoop portions 22, as shown in FIG. 3, thus define a smaller radius of curvature than the scoop of standard clamshell-type posthole digger. Cut out portion 26 of each blade 20, as shown in FIGS. 2 and 6, also provides more leverage during the digging operation; but it is possible to eliminate cut out portion 26 and extend neck portion 24 upward and completely about handle 14. Thus, as shown in FIG. 5, neck portions 24 partially encompass lower ends 18 of the respective handles 14 and seat and align handles 14 therein so that two pairs of handle securement fasteners 28, such as stove or carriage bolts, can be passed through apertures on neck portions 24 for securing handles 14 to the respective blades 20. It should also be noted that scoop portions 22 of blades 20 are generally more rounded than at their lower digging edge than standard clamshell-type posthole diggers in order to facilitate easier hole digging.

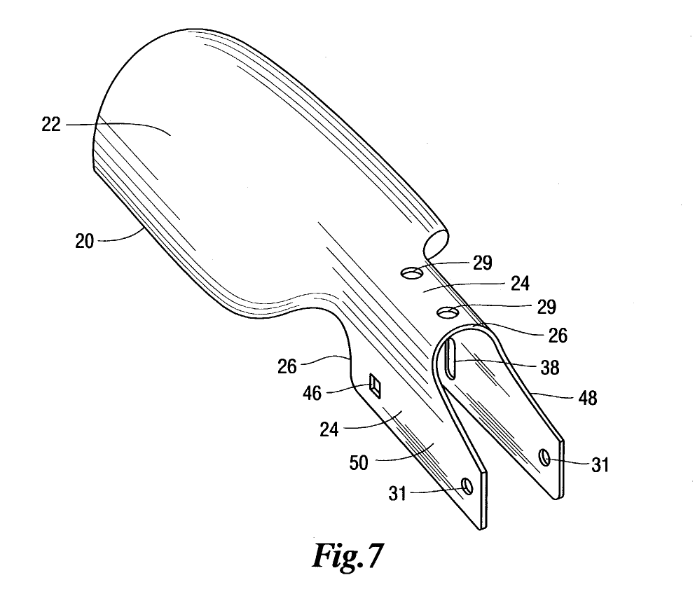

FIG. 7 shows digging blade 20 with scoop portion 22, neck or bracket portion 24, and cut out portion 26. Holes 29 receive handle securement fasteners 28 that are shown in FIG. 2. Holes 31 receive primary attachment fasteners 30, which may be pivot pins or bolts, as shown in FIG. 2. At a first side 48 of digger 10 first slide slot 38 in first blade 20 and first fixed slot 46 in second blade 20 receives first slide slot fastener 40. First slide slot fastener 40 is held in a fixed position in second blade 20, and is movably engaged in first slide slot 38 in first blade 20. Similarly, at a second side 50 of digger 10, second slide slot 38 in second blade 20 and second fixed slot 46 in first blade 20 receives second slide slot fastener 40. Second slide slot fastener 40 is held in a fixed position in first blade 20, and is movably engaged in second slide slot 38 in second blade 20. The pairs of slide slots 38 and fixed slots 46 and the first and second slide slot fasteners 40 control or limit the range of pivotal movement of first and second blades 20.

As shown in FIGS. 4, 5, and 7, neck portions 24 have a semi-circular shape and partially overlap each other adjacent the ear-like extensions so that blades 20 can be pivotally interconnected. Specifically, a primary attachment fastener 30, such as a pivot pin or bolt, is received through aligned apertures located where neck portions 24 overlap for pivotally interconnecting blades 20. A bushing 32 can be used to further support and protect pivot fastener 30 and washers 34 and jamb nuts 36 further secure pivot fastener 30 to the respective neck portions 24 of blades 20.

Illustrated in FIGS. 2 and 4 through 7 are means for setting and controlling the operational movement of handles 14 and blades 20 during hole digging. Specifically, the means for setting the position of handles 14 and blades 20, and for controlling or delimiting their pivotal movement, includes a pair of slide slots 38 formed in neck portion 24 of each blade 20. The present invention includes one slide slot 38 per blade 20, and when blades 20 are mounted to handles 14, slide slots 38 are disposed in axial alignment to each other. Thus, each blade 20, and, more specifically, neck portion 24 of each blade 20, includes one slide slot 38 and one fastener aperture with slide slot 38 located on one ear-like extension and the fasterner aperture located on the opposite ear-like extension of the opposite neck portion 24. When blades 14 are assembled so that they overlap adjacent the extensions of neck portions 24, slide slot 38 on one blade 20 is aligned with the fastener aperture on the other blade 20. Moreover, slide slot 38 of each blade 20 is disposed outboard of the fastener aperture on the other blade 20. A pair of slide slot fasteners 40, one for each aligned slide slot 38 and fastener aperture pair, are inserted therethrough for attaching blades 20 together. Slide slot fasteners 40 are thus able to slide within slots 38 concomitant with the individual moving and opening and closing handles 14 and blades 20 during a digging operation.

Thus, slide slots 38 delimit the pivotal movement of handles 14 and blades 20 to the full open position (as shown in FIG. 2), and to the full closed position. Slide slots 38 also prevent scoop portions 22 of blades 20 from striking each other when blades 20 have been moved or pivoted to the closed position; this is due to both the location of slide slots 38 on neck portions 24 and the length of slots 38. The length of slide slots 38 defines the range or extent of pivotal movement of handles 14 and blades 20 when moving back and forth from the full open to the full closed position. Furthermore, slide slots 38 assist in preventing the weaving or sloppy movement of blades 20 as blades 20 are pivoted back and forth from the open position for scooping up a quantity of dirt to the closed position for temporarily holding the dirt and then to the open position for releasing the dirt away from hole 12. The length of slots 38 must be appropriately sized so as to allow scoop portions 22 to close for scooping up a sufficient quantity of dirt; but slots 38 cannot be overlong such that too great a range of pivotal movement of handles 14 would be allowed thereby causing scoop portions 22 of blades 20 to strike against each other. FIG. 6 illustrates the ability of posthole digger 10 of the present invention to dig a deeper hole 12 with a generally uniform diameter throughout as compared to the type of hole 42 dug by a standard clamshell-type digger 44 wherein one must constantly widen hole 42 in order to go deeper thereby increasing the amount of labor expended.

While the invention has been described with respect to a specific embodiment, it is to be understood that the invention can accommodate numerous changes, modifications, and alterations without departing from the scope of the invention as set forth by the following appended claims.

I claim:

1. A posthole digger, comprising:
a pair of handles with each handle having an upper end and an opposite lower end;
a pair of blades with each blade secured to each respective handle and the blades interconnected for pivotal movement between an open digging position and a closed dirt removal position;
each blade including a scoop portion for hole digging and dirt removal, a neck portion with the neck portions partially overlapped for pivotal interconnection, and a slide slot for delimiting and controlling the range of pivotal motion of the handles and blades from the full open position to the full closed position, and the slide slots being in axial alignment with each other; and
the handles configured in an offset and angled disposition with respect to each other with the blades in the full open position so that the motion of the handles occurs in non-parallel planes whereupon the handles pass by each other and moved apart thereby causing the blades to pivot toward each other to the closed position for digging and the slide slots limiting the distance the handles can be pivoted away from each other thus allowing for the excavation of deep and narrow holes.

2. The posthole digger of claim 1 wherein the handles are angled inwardly toward each other at an angle of approximately five degrees when the handles are disposed in the full open position.

3. The posthole digger of claim 2 wherein the neck portions of each blade include a pair of opposed ear-like extensions that are transverse to the scoop portions and the ear-like extension of one blade partially overlaps and abuts the ear-like extension of the other blade.

4. The posthole digger of claim 3 wherein the blades are pivotally interconnected by a primary pivot pin that extends transversely through the neck portions of both blades.

5. The posthole digger of claim 4 wherein for each neck portion of each blade one slide slot is located on one ear-like extension and one fastener aperture is located on the opposite ear-like extension and the slide slot and fastener aperture are disposed in axial alignment with each other.

6. A posthole digger, comprising:
a pair of blades pivotally interconnected so that the blades can move between an open position and a closed position for digging into soil and for removing soil so that a hole can be excavated;
a pair of handles with each handle having an upper end and an opposite lower end with the lower end secured to each respective blade, the handles being angled toward each other and overlapping each other when the blades are set in the open position;
the handles being offset from each other so that the working motion of the handles occurs in non-parallel planes; and
each blade having a slide slot and a slide slot fastener inserted therethrough with the slide slots being in axial alignment whereupon the range of pivotal movement of the handles and blades from the full open position to the closed position is controlled and limited by the movement of each slide slot fastener within each slide slot and the movement of the slide slot fasteners within the slide slots occurring simultaneous with the pivotal movement of the handles and blades.

7. The posthole digger of claim 6 wherein the handles are angled toward each other at approximately five degrees when the handles and blades are set in the full open position.

8. The posthole digger of claim 7 wherein each blade includes a scoop portion for digging and removing dirt and a hinge bracket portion that encloses the lower end of the handle so that the handle can be secured to the hinge bracket portion.

9. The posthole digger of claim 8 wherein the hinge bracket portions are disposed in partially overlapping and abutting relationship so that the hinge bracket portions can be pivotally interconnected.

10. The posthole digger of claim 9 wherein a pivot pin extends through the hinge bracket portions of both blades for pivotally interconnecting the blades so that the blades can be moved from the full open position to the closed position.

11. A posthole digger, comprising:
a pair of elongated handles with each handle having an upper end and an opposite lower end;
a pair of blades with each blade mounted to each respective handle and each blade having a scoop portion for digging, holding and removing the dirt, and a hinge bracket portion with the hinge bracket portions disposed in abutting relationship for pivotally interconnecting the blades so that the handles and blades can be moved from a full open position to a closed position for removing dirt and digging a hole;
the handles being angled toward each other at approximately five degrees and arranged in an offset and overlapping configuration when the blades are set in the full open position; and
means to control and limit the pivotal movement of the handles and blades from the full open position to the closed position so that the full open position and closed position are preset for facilitating the digging of deep, narrow holes having a generally uniform diameter.
